(19) United States
(12) Patent Application Publication
(10) Pub. No.: US 2003/0191625 A1
(43) Pub. Date: Oct. 9, 2003

(54) Method and system for creating a named entity language model

(76) Inventors: Allen Louis Gorin, Berkeley Heights, NJ (US); Frederic Bechet, Avignon (FR); Jeremy Huntley Wright, Berkeley Heights, NJ (US); Dilek Z. Hakkani-Tur, Hoboken, NJ (US)

Correspondence Address: KENYON & KENYON, 1500 K STREET, N.W., SUITE 700, WASHINGTON, DC, 20005, US

(21) Appl. No.: 10/402,976

(22) Filed: Apr. 1, 2003

Related U.S. Application Data
(63) Continuation-in-part of application No. 10/158,082, filed on May 31, 2002.
(63) Continuation-in-part of application No. 09/690,721, filed on Oct. 18, 2000.
(63) Continuation-in-part of application No. 09/690,903, filed on Oct. 18, 2000.
(60) Provisional application No. 60/443,642, filed on Jan. 29, 2003.
(60) Provisional application No. 60/322,447, filed on Sep. 17, 2001.
(60) Provisional application No. 60/163,838, filed on Nov. 5, 1999.

(51) Int. Cl. G06F 17/20

(52) U.S. Cl. 704/1

(57) ABSTRACT

The invention concerns a method and system for creating a named entity language model. The method may include recognizing input communications from a training corpus, parsing the training corpus, tagging the parsed training corpus, aligning the recognized training corpus with the tagged training corpus, and creating a named entity language model from the aligned corpus.

This non-provisional application claims the benefit of U.S. Provisional Patent Application No. 60/307,624, filed Apr. 5, 2002, and U.S. Provisional Patent Application No. 60/443,642, filed Jan. 29, 2003, which are both incorporated herein by reference in their entireties. This application is also a continuation-in-part of 1) U.S. Patent Application No. 10/158,082 which claims priority from U.S. Provisional Patent Application No. 60/322,447, filed Sep. 17, 2001, 2) U.S. Patent Application No. 09/690,721 and 3) No. 09/690,903 both filed Oct. 18, 2000, which claim priority from U.S. Provisional Application No. 60/163,838, filed Nov. 5, 1999. U.S. patent application Ser. Nos. 09/690,721, 09/690,903, 10/158,082 and U.S. Provisional Application Nos. 60/163,838 and 60/322,447 are incorporated herein by reference in their entireties.

### TECHNICAL FIELD

The invention relates to automated systems for communication recognition and understanding.

### BACKGROUND OF THE INVENTION

Examples of conventional automated dialogue systems can be found in U.S. Pat. Nos. 5,675,707, 5,860,063, 6,021,384, 6,044,337, 6,173,261 and 6,192,110, which are incorporated herein by reference in their entireties. Interactive spoken dialogue systems are now employed in a wide range of applications, such as directory assistance or customer care on a very large scale. Dealing with a large population of non-expert users results in a great variability in the spontaneous communications being processed. This variability requires a very high robustness from every part of dialogue system.

In addition, the large amount of real data collected through these dialogue systems raises many new dialogue system training issues and makes possible the use of even more automatic learning and corpus-based methods at each step of the dialogue process. One of the issues that these developments have raised is the role of the dialogue system in determining, firstly what kind of query the database is going to be asked and secondly with which parameters.

### SUMMARY OF THE INVENTION

The invention concerns a method and system for creating a named entity language model. The method may include recognizing input communications from a training corpus, parsing the training corpus, tagging the parsed training corpus, aligning the recognized training corpus with the tagged training corpus, and creating a named entity language model from the aligned corpus.

### BRIEF DESCRIPTION OF THE DRAWINGS

The invention is described in detail with reference to the following drawings wherein like numerals reference like elements, and wherein:

FIG. 1 is a block diagram of an exemplary communication recognition and understanding system;

FIG. 2 is a detailed block diagram of an exemplary named entity training unit;

FIG. 3 is a detailed flowchart illustrating an exemplary named entity training process;

FIG. 4 is a detailed block diagram of an exemplary named entity detection and extraction unit;

FIG. 5 is a detailed block diagram of an exemplary named entity detector;

FIG. 6 is a flowchart illustrating an exemplary named entity detection and extraction process; and

FIG. 7 is a flowchart of an exemplary task classification process.

### DETAILED DESCRIPTION OF THE PREFERRED EMBODIMENTS

A dialogue system can be viewed as an interface between a user and a database. The role of the system is to determine first, what kind of query the database is going to be asked, and second, with which parameters. For example, in the How May I Help You?^{SM, TM} (HMIHY) customer care corpus, if a user wants his or her account balance, the query concerns accessing the account balance field of the database with the customer identification number as the parameter.

Such database queries are denoted by task-type (or in this example, call-type) and their parameters are the information items that are contained in the user's request. They are often called “named entities”. The most general definition of a named entity is a sequence of words, symbols, etc. that refers to a unique identifier. For example, a named entity may refer to:

proper name identifiers, like organization, person or location names;

time identifiers, like dates, time expressions or durations; or

quantities and numerical expressions, like monetary values, percentage or phone numbers.

In the framework of a dialogue system, the definition of a named entity is often associated to its meaning for the application targeted. For example, in a customer care corpus, most of the relevant time or monetary expressions may be those related to an item on a customer's bill (the date of the bill, a date or an amount of an item or service, etc.).

In this respect, there are context-dependent named entities that are named entities whose definition is linked to the dialogue context, and context-independent named entities that are independent from the dialogue application (e.g., a date). One of the aspects of the invention described herein is the detection and extraction of such context-dependent and independent named entities from spontaneous communications in a mixed-initiative dialogue context.

Within the dialogue system, the module that is responsible for interacting with the user is called a dialogue manager. Dialogue managers can be classified according to the type of the type of system interaction implemented, including system-initiative, user-initiative or mixed-initiative.

A system-initiative dialogue manager handles very constrained dialogues where the user has to answer to direct questions by either one key word or a simple short sentence. The task to fulfill can be rather sophisticated but the user has to be cooperative and patient as the language accepted is not spontaneous and the list of questions asked can be quite long.

A user-initiative dialogue manager gives the user the possibility of directing the dialogue. The system waits to know what the user wants before asking a specific question. In this case, spontaneous communications have to be accepted. However, because of the difficulty in processing such spontaneous input, the range of tasks which can be addressed within a single application is limited. Thus, in a customer care system, the first stage of attempting to “understand” a user's query involves classifying the user's intent according to a list of task-types specific to the application.

A customer care corpus, for example, may contain dialogue belonging to a third category which is known as mixed-initiative dialogue manager systems. In this case, the top-level of the dialogue implements a user-initiative dialogue by simply asking the user “How may I help you?”, for example. A short dialogue sometimes ensues for clarifying the request, and finally the user is sent to either an automated dialogue system or a human representative depending on the availability of such an automatic process for the request recognized.

According to the above-described dialogue manager interaction type implemented, the performance of the named entity extraction task strongly varies. For example, extracting a phone number is much easier in a system-initiative context where the user has to answer to a prompt like “Please give me your home phone number starting with line area code”, than in a user-initiative dialogue where a phone number is not expected and is likely to be embedded into a long spontaneous utterance such as:

Okay, my name is XXXX from Sarasota Fla. telephone number area code XXX XXXXXXX and there's a two nine four beside it but I don't what that means anyways on December the thirty first at one thirty five P M I w-there was a call from our number called to area code XXX XXXXXXX.

Accordingly, one of the aspects of this invention addresses how to automatically process such spontaneous responses. In particular, this invention concerns a dialogue system that automatically detects and extracts, from a recognized output, the task-type request expressed by a user and its parameters, such as numerical expressions, time expressions or proper names. As noted above, these parameters are called “named entities” and their definitions can be either independent from the context of the application or strongly linked to the application domain. Thus, a method and system that trains named entity language models, and a method and system that detects and extracts such named entities to improve understanding during an automated dialogue session with a user, will be discussed in detail below.

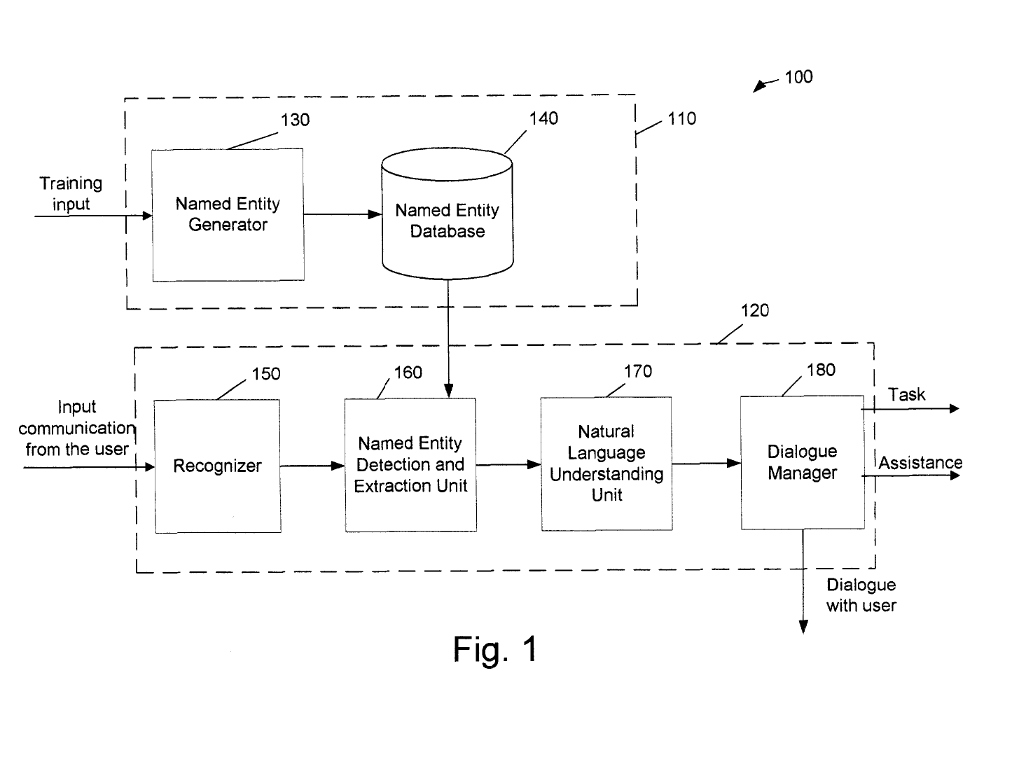

FIG. 1 is an exemplary block diagram of a possible communication recognition and understanding system 100 that utilizes named entity detection and extraction. The exemplary communication recognition and understanding system 100 includes two related subsystems, namely a named entity training subsystem 110 and input communication processing subsystem 120.

The named entity training subsystem 110 includes a named entity training unit 130 and a named entity database 140. The named entity training unit 130 generates named entity language models and a text classifier training corpus from a training corpus of transcribed or untranscribed training communications. The generated named entity language models and text classifier training corpus are stored in the named entity database 140 for use by the named entity detection and extraction unit 160.

The input communication processing subsystem 120 includes an input communication recognizer 150, a named entity detection and extraction unit 160, a natural language understanding unit 170 and a dialogue manager 180. The input communication recognizer 150 receives a user's task objective request or other communications in the form of verbal and/or non-verbal communications. Non-verbal communications may include tablet strokes, gestures, head movements, hand movements, body movements, etc.). The input communication recognizer 150 may perform the function of recognizing or spotting the existence of one or more words, phones, sub-units, acoustic morphemes, non-acoustic morphemes, morpheme lattices, etc., in the user's input communications using any algorithm known to one of ordinary skill in the art.

One such algorithm may involve the input communication recognizer 150 forming a lattice structure to represent a distribution of recognized phone sequences, such as a probability distribution. For example, the input communication recognizer 150 may extract the n-best word strings that may be extracted from the lattice, either by themselves or along with their confidence scores. Such lattice representations are well known those skilled in the art and are further described in detail below. While the invention is described below as being used in a system that forms and uses lattice structures, this is only one possible embodiment and the invention should not be limited as such.

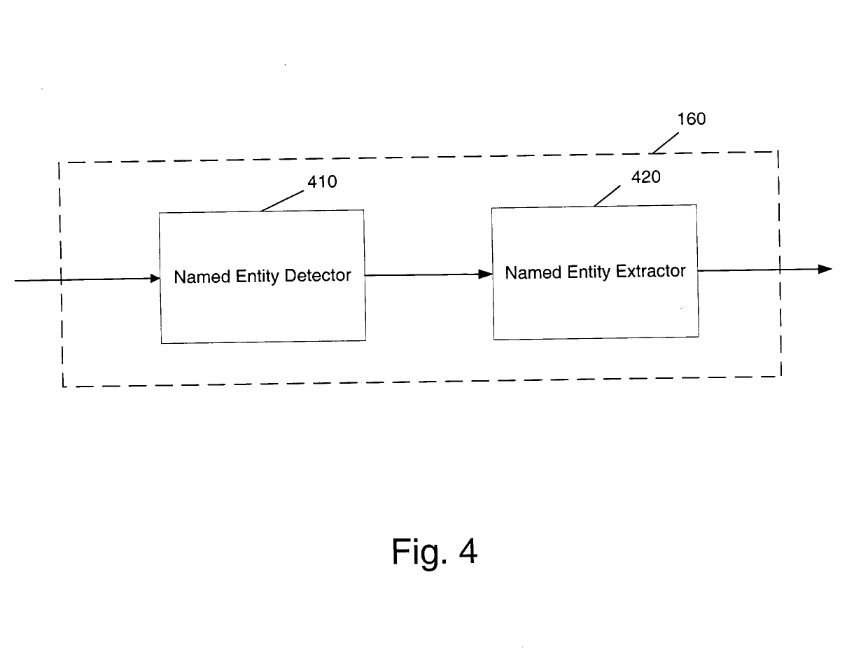

The named entity detection and extraction unit 160 detects the named entities present in the lattice that represents the user's input request or other communication. The named entity detection and extraction unit 160 then tags and classifies detected named entities and extracts the named entity values using a process such as discussed in relation to FIGS. 4-6 below. These extracted values are then provided as an input to the natural language understanding unit 170.

The natural language understanding unit 170 may apply a confidence function, based on the probabilistic relationship between the recognized communication including the named entity values and selected task objectives. As a result, the natural language understanding unit 170 will pass the information to the dialogue manager 180. The dialogue manager 180 may then make a decision either to implement a particular task objective, or determine that no decision can made based on the information provided, in which case the user may be defaulted to a human or other automated system for assistance. In any case, the dialogue manager 180 will inform the user of the status and/or solicit more information.

The dialogue manager 180 may also store the various dialogue iterations during a particular user dialogue session. These previous dialogue iterations may be used by the dialogue manager 180 in conjunction with the current user input to provide an acceptable response, task completion, or task routing objective, for example.

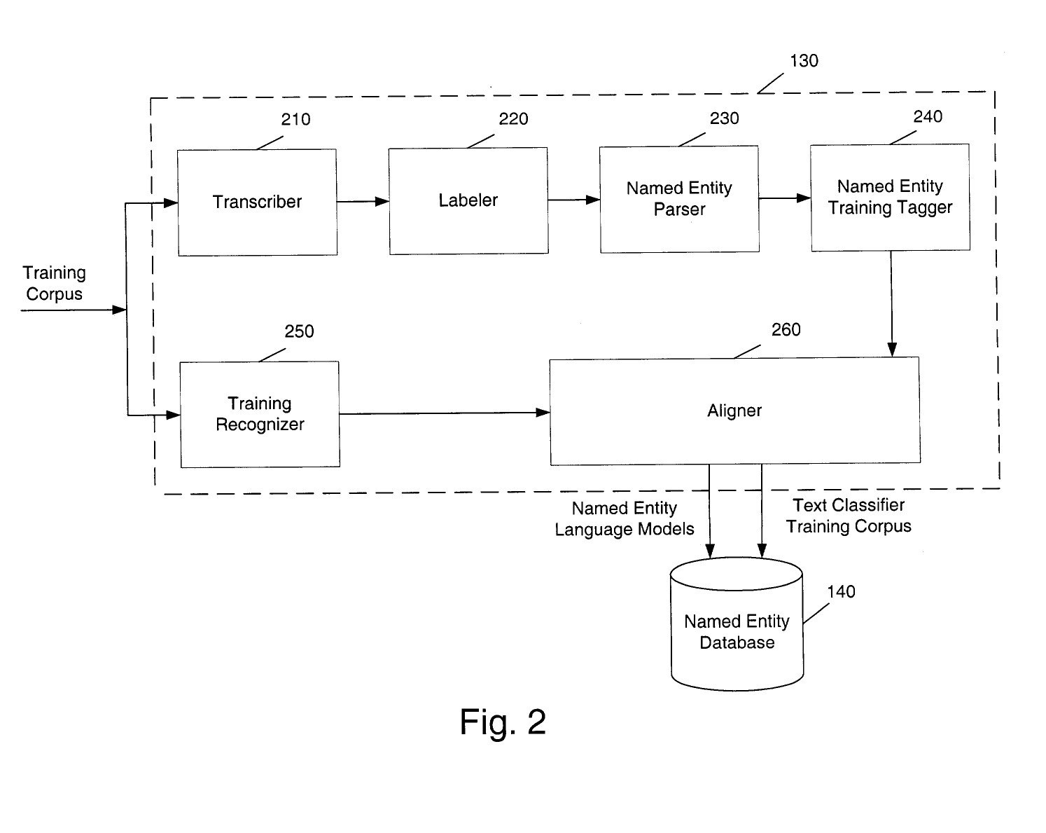

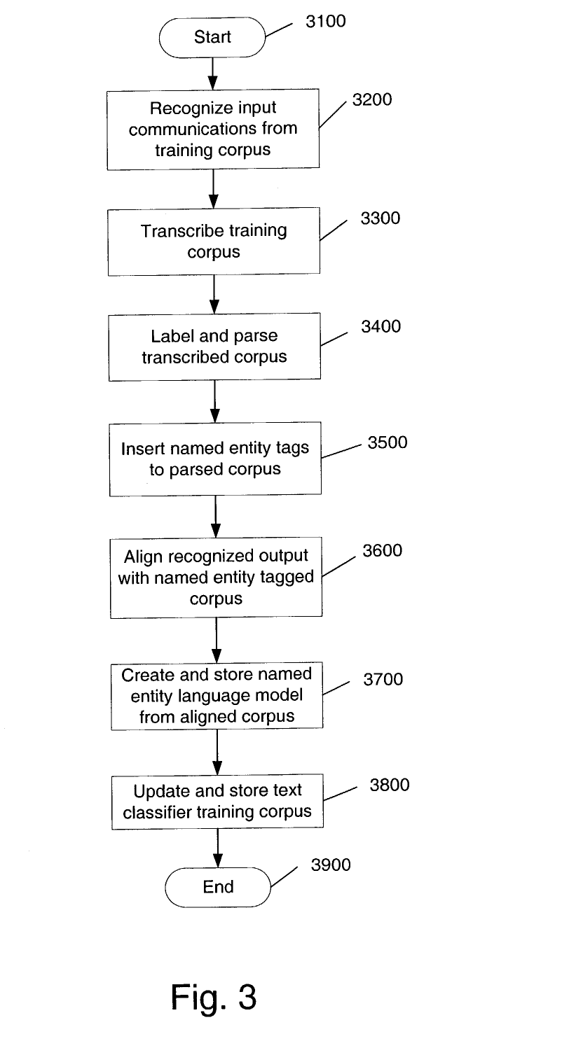

FIG. 2 is a more detailed diagram of the named entity training subsystem 110 shown in FIG. 1. The named entity training unit 130 may include a transcriber 210, a labeler 220, a named entity parser 230, a named entity training tagger 240, a training recognizer 250, and an aligner 260. The named entity language model and text classifier training corpus generated by the named entity training unit 130 are stored in the named entity database 140 for use by the named entity detection and extraction unit 160. The operation of the individual units of the named entity training subsystem 110 will be discussed in detail with respect to FIG. 3 below.

FIG. 3 illustrates an exemplary named entity training process for using the named entity training subsystem 110 shown in FIGS. 1 and 2. Note that while the steps of any of the exemplary flowcharts illustrated herein are shown having steps arranged in a particular order, the order of the steps in the figures may be rearranged to be performed in any order, or simultaneously, for example.

The process in FIG. 3 begins at step 3100 and proceeds to step 3200 where the training corpus is input into a task-independent training recognizer 250. The recognition process may involve a phonotactic language model that was trained on the switchboard corpus using a Variable-Length N-gram Stochastic Automaton, for example. This training corpus may be derived from a collection of sentences generated from the recordings of callers responding to a system prompt, for example. In experiments conducted on the system of the invention, 7642 and 1000 sentences in the training and test sets were used, respectively. Sentences are represented at the word level and provided with semantic labels drawn from 46 call-types. This training corpus may be unrelated to the system task. Moreover, off-the-shelf telephony acoustic models may be used.

In step 3300, the transcriber 210 also receives raw training communications from the training corpus in conjunction with the training corpus being put through the training recognizer 250. The processes in steps 3200 and 3300 may be performed simultaneously. In the traditional approach, corpora of spontaneous communications dedicated to a specific application are small and obtained by a particular protocol or a directed experiment trial. Because of their small size, these training corpora may be integrally transcribed by humans. In large-scale dialogue systems, the amount of live customer traffic is very large and the cost of transcribing all of the data available would be enormous.

In this case, a selective sampling process may be used in order to select the dialogues that are going to be labeled. This process can be done randomly, but by being able to extract information from the recognizer output in an unsupervised way, the selection method can be made more efficient. For example, some rare task types or named entities can be very badly modeled because of the lack of data representing them. By automatically detecting named entity tags, specifically selected dialogues can be represented that are likely to contain them, and accelerate in a very significant way, the coverage of the training corpus.

The dual process shown in FIG. 2 is important to improve the quality of named entity detection and extraction. For instance, consider that named entities are usually represented by either handwritten rules or statistical models. Even if statistical models seem to be much more robust toward recognizer errors, in both cases the models are derived from communications transcribed by the transcriber 210 and the errors from the training recognizer 250 are not taken into account explicitly by the models.

This strategy certainly emphasizes the precision of the resulting detection, but a great loss in recall can occur by not modeling the training recognizer's 250 behavior. For example, a word can be considered as very salient information for detecting a particular named entity tag. But if this word is, for any reason, very often badly recognized by the training recognizer 250, its salience won't be useful on the output of the system. For this reason, the training recognizer's 250 behavior in the contextual named entity tagging process is explicitly modeled.

In step 3400, the transcribed corpus is then labeled by the labeler 220 and parsed by the named entity parser 230. In this manner, the labeler 220 classifies each sentence according to the list of named entity tags contained in it. Then for each sentence, the named entity parser 230 marks all of the words or group of words selected by the labeler 220 for characterizing the sentence according to the named entity tags. In this manner, the named entity parser 230 marks the part-of-speech of each word and performs a syntactic bracketing on the corpus.

In step 3500, as a way to make the user's input communication useful to the dialogue manager 180, the named entity training tagger 240 inserts named entity tags on the labeled and parsed training corpus. This process may include using the list of named entity tags included in each of sentence as well as using both statistic and syntactic criteria to present which context is considered salient for identifying named entities.

For example, consider the following four exemplary named entity tags:

(1) Date: any date expression with at least a day and a month specified;

(2) Phone: phone numbers expressed in a 10 or 11-digit string;

(3) Item_Amount: money expression referring to a charge written on the customer's bill;

(4) Which_Bill: a temporal expression identifying the bill the customer is talking about.

The first two tags can be considered as context-independent named entities. For example, “Date” can correspond to any date expression. In addition, nearly all of the 10 or 11-digit strings in the customer care corpus are effectively considered “Phone” numbers.

In contrast, the last two tags are context-dependent named entities. “Which_Bill” is not any temporal expression but an expression that allows identification of a customer's bill. “Item_Amount” refers to a numerical money expression that is explicitly written on the bill. According to this definition, the following sentence contains an Item_Amount tag: I don't recognize this 22 dollars call to . . . but this one doesn't: he told me we would get a 50 dollars gift . . . .

Thus, each named entity tag can correspond to one or several kinds of values. To the tags Phone, Item_Amount and Date correspond only one type of pattern for their values (respectively: 10-digit string, <num>$<num><cents>and<year>/<month>/<day>). But Which Bill can be either a date (dates of the period of the bill, date of arrival of the bill, date of payment, etc.) or a relative temporal expression like current or previous.

For the named entity tagging process, the named entity tagger 240 may use a probabilistic tagging approach. This approach involves is a Hidden Markov Model (HMM) where each word of a sentence is emitted by a state in the model. The hidden state sequence S=(s₁. SN) corresponds to the following situations: beginning a named entity, being inside a named entity, ending a named entity, being in the background text.

Finding the most probable sequence of state which have produced the known word sequence W=(w₁ . . . w_{N}) is equivalent to maximizing the probability: P(S/W). By using Bayes' rule and the assumption that the state at time “f” is only dependent on the state and observation at time t−1, according to equation (1) below:

$$P ( S \vert W ) \approx arg {max}_{S} {\prod }_{t = 1}^{N} P ( {w}_{t} \vert {w}_{t - 1} , {s}_{t} ) P ( {s}_{t} \vert {s}_{t - 1} , {w}_{t - 1} )$$

The first term, P(wₜ/wₜ₋₁,sₜ), is implemented as a state-dependent bigram model. For example, if sₜ is the state inside a PHONE, this first term corresponds to the bigram probability Pₚₕₒₙₑ (wₜ/wₜ₋₁) estimated on the corpus C_{NE}. Similarly, the bigram probability for the background text, P_{bk} (wₜ/wₜ₋₁), is estimated on the corpus C_{BK}.

The second term is the state transition probability of going from the state t−1 to the state t. These probabilities are estimated on the training corpus, once the named entity context selection process has been done. The context corresponds to the smallest portion of text, containing the named entity, which allows the labeler 220 to decide that a named entity is occurring.

As it has been previously shown, not all the named entities are considered relevant for the natural language understanding unit 170. Therefore, the named entity training tagger 240 must model not only the named entity itself (e.g., 20 dollars and 40 cents) but its whole context of occurrence (e.g., . . . this 20 dollars and 40 cents call . . . ) in order to disambiguate relevant named entities from others. Thus, the relevant context of a named entity tag in a sentence is the concatenation of all the syntactic phrases containing a word marked by the named entity parser 230.

After processing the whole training corpus, two corpora are attached to each tag:

(1) the corpus C_{NE} containing only named entity contexts (e.g., <PH>my phone area code d3 number d7</PH>); and

(2) the corpus CBK which contains the background text without the named entity contexts (e.g., I'm calling about <PH></PH>).

In both cases, non-terminal symbols are used for representing numerical values and proper names.

As discussed above, in conjunction with the training of the named entity language model, this process takes into account the recognition errors explicitly in that model. In this manner, the whole training corpus is also processed by the training recognizer 250 as discussed in relation to step 3200 above, in order to learn automatically the confusions and the mistakes which are likely to occur in a deployed communication recognition and understanding system 100.

Therefore, in the transcribed part of the customer care corpus, each named entity may be represented by three items: tag, context and value.

As part of the final process, in step 3600 the aligner 260 aligns the training recognizer's 250 output corpus, at the word level, with the transcribed corpus that has been tagged by the named entity training tagger 240. Then, in step 3700, a named entity language model is created. This named entity language model may be a series of regular grammars coded as Finite-State-Machines (FSMs). The aligner 260 creates named entity language models after the transcribed training corpus is labeled, parsed and tagged by the named entity training tagger 240 in order to extract named entity contexts on the clean text.

Only the named entity contexts correctly tagged according to the labels marked by the labeler 220 are kept. Then, all the digits, natural numbers and proper names are replaced by corresponding non-terminal symbols. Finally, all of the patterns representing a given tag are merged in order to obtain one FSM for each tag coding the regular grammar of the patterns found in the corpus.

The corpora C_{NE} and C_{BK} are replaced by their corresponding sections in the recognizer output corpus and stored along with the named entity language models in the named entity training database 140. As such, the inconvenience of learning directly a model on a very noisy channel is balanced by structuring the noisy data according to constraints obtained on the clean channel. This leads to an increase in performance.

Specifically, the training recognizer 250 can generate, as output, a word-lattice as well as the highest probability hypothesis called the 1-best hypothesis. In customer care applications, the word-error-rate of the 1-best hypothesis is around 27%. However, by having the aligner 260 perform an alignment between the transcribed data and the word lattices produced by the training recognizer 250, the word-error-rate of the aligned corpus drops to around 10%.

In step 3800, the recognized training corpus is updated using the aligned corpus and also stored in the named entity database 140 for use in the text classification performed by the named entity detection and extraction unit 160. In this process, the aligner 260 processes the text classifier training corpus using the named entity tagger 240 with no rejection. On one side, all of the named entities that are correctly tagged by the named entity tagger 240 according to the labels given by the labeler 220 are kept. On the other side, all the false positive detections are labeled by aligner 260 with the tag OTHER. Then, the text classifier 520 (introduced below) is trained in order to separate the named entity tags from the OTHER tags using the text classifier training corpus. The process goes to step 3900 and ends.

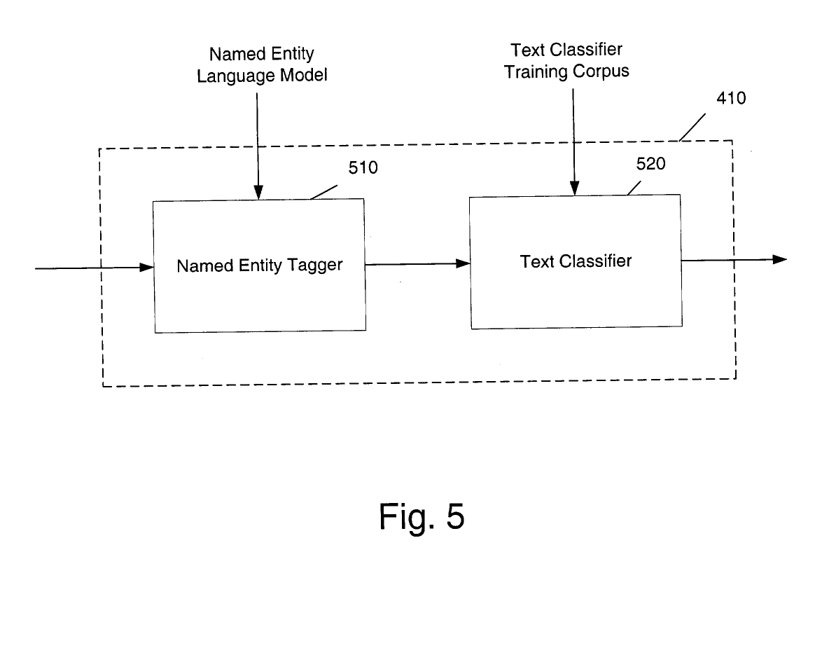

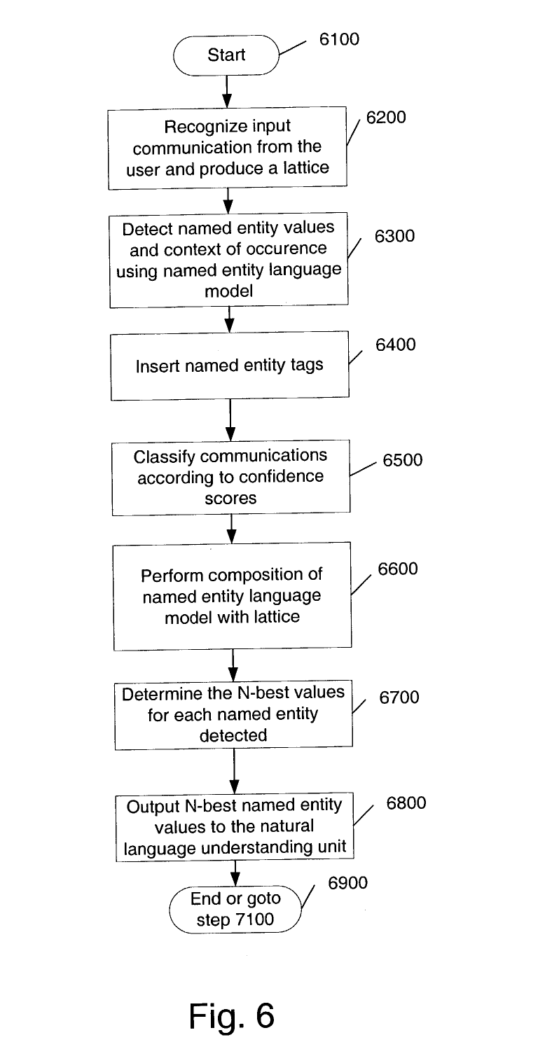

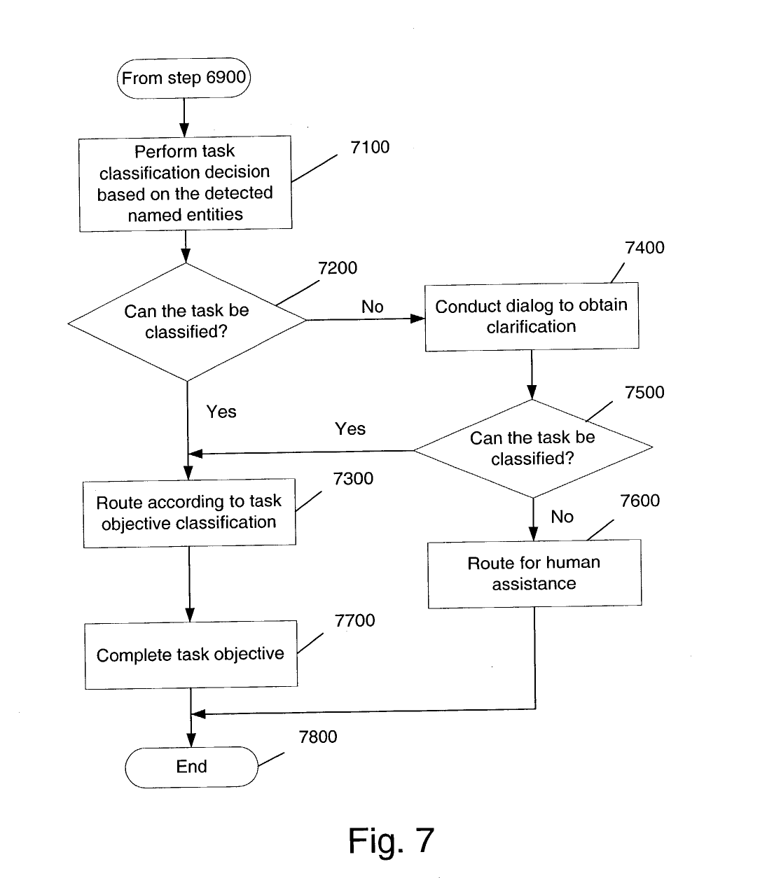

The named entity detection and extraction process will now be discussed in relation to FIGS. 4-7. More particularly, FIGS. 4 and 5 illustrate more detailed exemplary diagrams of portions of input communication processing subsystem 120 and FIGS. 6 and 7 illustrate an exemplary named detection and extraction process and an exemplary task classification process, respectively.

FIG. 4 illustrates an exemplary named entity detection and extraction unit 160. The named entity detection and extraction unit 160 may include a named entity detector 410 and named entity extractor 420.

FIG. 5 is a more detailed block diagram illustrating an exemplary named entity detector 410. The named entity detector 410 may include a named entity tagger 510 and a text classifier 520. The operations of individual units shown in FIGS. 4 and 5 will be discussed in detail in relation to FIGS. 6 and 7 below.

FIG. 6 is an exemplary flowchart illustrating a possible named entity detection and extraction process using the exemplary system described in relation to the figures discussed above.

In this regard, the named entity detection and extraction process begins at step 6100 and proceeds to step 6200 where the input communication recognizer 150 recognizes the input communication from the user and produces a lattice.

In an automated communication recognition process, the weights or likelihoods of the paths of the lattices are interpreted as negative logarithms of the probabilities. For practical purposes, the pruned network will be considered. In this case, the beam search is restricted in the lattice output, by considering only the paths with probabilities above a certain threshold relative to the best path.

Most recognizers can generate, as output, a word-lattice as well as the highest probability hypothesis called 1-best hypothesis. This lattice generation can be made at the same time as the 1-best string estimation with no further computational cost. As discussed above, in the customer care corpus, the word error rate of the 1-best hypothesis is around 27%. However, by performing an alignment between the transcribed data and the word lattices produced by the recognizer, the word error rate of the aligned corpus (called the oracle word error rate) dropped to approximately 10%. This simply means that, although the system has nearly all the information for decoding the corpus, most of the time the correct transcription is not the most probable one according to the recognition probabilistic models.

Past studies attempted to take advantage of the oracle accuracy of the word lattice in order to re-score hypotheses. A small improvement in the word error rate is generally obtained by these techniques but the main advantage attributed to them is the calculation of a confidence score, for each word, integrating both an acoustic and linguistic score into a posterior probability. Nevertheless, these techniques, as well as those based on a mufti-recognizer, still output a re-scored 1-best hypothesis, which is very far from the oracle hypothesis that can be found in the word-lattice.

One of the main reasons for this difference in performance between 1-best and oracle hypothesis is due to the fact that recognizer probabilistic models maximize globally the probability of finding the correct sentence. By having to perform equally well on every part of a communication input, the recognizer model is not always able to characterize properly some local phenomenon.

For example, it has been shown that having a specific model for recognizing numeric language in conversational speech improves significantly the performances. However, such a model can be used only to decode answers to a direct question asking for a numerical value, and in a user-initiative dialogue context, the kind of language the caller is going to use is not known in advance. For these reasons, a word lattice transformed in a chain-like structure called Word Confusion Network (WCN) and coded as a Finite State Machine (FSM), is provided as an input to the NLU unit 170.

The training recognizer 250 generally produces word lattices during the recognition process as an intermediate step. Even if they represent a reduced search-space compared to the first one obtained after the acoustic parameterization, they still can contain a huge number of paths, which limits the complexity of the methods that can be applied efficiently to them. For example, the named entity parser 230 statistically parses the input word lattice by first pruning the word lattice in order to keep the 1000 best paths.

In addition, Word Confusion Networks (WCN) can be seen as another kind of pruning. The main idea consists in changing the topology of the lattice in order to reflect the time-alignment of the words in the signal. This new topology may be a concatenation of word-sets.

During this transformation, the word lattice is pruned and the score attached to each word is calculated to represent the posterior probability of the word (i.e., the sum of the probabilities of all the paths leading to the word) and some new paths can appear by grouping words into sets. An empty transition (called epsilon transition) is also added to each word set in order to complete the probability sum of all the words of the set to 1.

The main advantages of this structure are as follows. First, their size as they are about a hundred times smaller than the originally used lattice. Secondly, the posterior probabilities that can be used directly as a confidence score for each word. Finally, the topology of the network itself because by selecting two states, S1 and S2 that correspond to a given time zone on the signal, all the possible paths covering this zone start at S1 and end at S2 are sure to be covered. In the original lattice, the topology does not directly reflect the time alignment of the words, and enumerating all the paths between two states does not guarantee that no other paths exist on the same time interval.

In step 6300, the named entity tagger 510 of the named entity detector 410 detects the named entity values and context of occurrence using the named entity language models stored in the named entity database 140.

In step 6400, the named entity tagger 510 inserts named entity tags on the detected named entities. The named entity tagger 510 maximizes the probability expressed by the equation (1) above by means of a search algorithm. The named entity tagger 510 may give to each named entity tag a confidence score for being contained in a particular sentence, without extracting a value. These named entity tags by themselves are a useful source of information for several modules of the dialogue system. Their usefulness is discussed in further detail below.

Then, in step 6500, in order to be able to tune the precision and the recall of the named entity language models for the recognition and understanding system 120, each named entity detected by the named entity tagger 510 is scored by the text classifier 520. The scores given by the text classifier 520 are used as confidence scores to accept or reject a named entity tag according to a given threshold. As discussed above, the text classifier 520 was trained to separate the named entity tags from the OTHER tags using the text classifier training corpus stored in the named entity database 140.

After the named entities are detected, they are extracted using the named entity extractor 420. A 2-step approach is undertaken for extracting named entity values. This approach is taken because it is difficult to predict exactly what the user is going to say after a given prompt so that the named entities are detected on the 1-best hypothesis produced by the recognizer 150.

In addition, once detected areas in the input communications which are likely to contain named entities with a high confidence score are identified by the text classifier 520, the named entity extractor 420 extracts the named entity values from the word lattice using the named entity language models stored in the named entity database 140 (specific to each named entity tag). However, only on the areas selected by the named entity tagger 510.

Extracting named entity values is crucial in order to complete a user's request because these values represent the parameters of the database queries. In system-initiative dialogue systems, each named entity value is obtained by a separate question and named entities embedded in a sentence are usually ignored. For mixed-initiative dialogue systems it is important for the named entity extractor 420 to extract the named entity values as soon as the caller expresses them, even if the dialogue manager 180 hasn't explicitly asked for them. This point is particularly crucial in order to make the dialogue feel natural to the user. While extracting named entity values embedded in a sentence is much more difficult than processing answers to a direct question, the named entity extractor 420 can use, for this purpose, all the information that has been collected during the previous iterations of the dialogue.

For example, in a customer care application, as soon as the customer is identified, all of the information contained in his bill could be used. If a query concerns an unrecognized call on a bill, the phone number to detect is contained in the bill, among all the other calls (N) made during the same period. Extracting a 10-digit string among N (with N of order a few tens) is significantly easier than finding the right string among the 1010 possible digit strings.

In step 6600, the named entity extractor 420 performs a composition operation between the FSM associated to a named entity tag and an area of the word-lattice where such a tag has been detected by the named entity tagger 510. Because having a logical temporal alignment between words makes the transition between 1-best hypothesis and word-lattice easier, and because posterior probabilities are powerful confidence measures for scoring words, the word-lattices produced by the input communication recognizer 150 may be first transformed into a chain-like structure (also called “sausages”).

Once the named entity extractor 420 composes the FSM with the portion of the chain corresponding to the named entity area detected, in step 6700, the named entity extractor 420 searches for the best path according only to the confidence scores attached to each word by the text classifier 520 in the chain. The FSM is not weighted, as all the patterns extracted by the named entity extractor 420 from the named entity language model are considered valid. Therefore, only the posterior probability of each sequence of word following the patterns is taken into account. According to the kind of named entity tag extracted by the named entity extractor 420, the named entity extractor 420 performs a simple filtering process of the best path in the FSM in order to output values to the natural language understanding unit 170, in step 6800.

Traditionally, the natural language understanding unit 170 component of a dialogue system is located between the recognizer 150 component and the dialogue manager 180. The recognizer 150 outputs the best string of words estimated from the speech input according to the acoustic and language models with a confidence score attached to each word. The goal of the natural language understanding unit 170 is then to extract semantic information from this noisy string of words in order to give it to the dialogue manager 180. This architecture relies on the assumption that ultimately the progress made by automated communication recognition technology will allow the recognizer 150 to transcribe almost perfectly the communication input. Accordingly, as discussed above, a natural language understanding unit 170 may be designed and trained on manual transcriptions of human-computer dialogues.

This assumption is reasonable when the language accepted by the dialogue application is very constrained, like in system-initiative dialogue systems. However, it becomes unrealistic when dealing with conversational spontaneous communications. This is because of the Out-Of-Vocabulary (OOV) word phenomenon which is inevitable, even with a very large recognition lexicon (occurrences of proper names like customers name, for example) and also because of the ambiguities intrinsic to spontaneous communication. Indeed, transcribing and understanding are two processes that should be done simultaneously as most of the transcription ambiguities of spontaneous speech can only be resolved by some understanding of what is being said.

Thus, the usual architecture of dialogue systems may be modified by integrating the transcription process into the natural language understanding unit 170. Instead of producing only one string of words, the recognizer 150 will output a word lattice where the different paths can correspond to different interpretations of the communication input.

The process then goes to step 6900 and ends or continues to step 6100, if the named entity process is applied to a task classification system process.

The above processes discussed in relation to FIGS. 3 and 6 will be explained in further detail below. This discussion will also cover how the processes are integrated.

Earlier methods developed for the named entity detection task were dedicated to process proper name named entities like person, location or organization names, and little attention had been given to the process of numerical named entities. This was mainly due to the importance of proper names in the corpus processed (news corpus) and also because these named entities are much more ambiguous and difficult to detect and recognize than the numerical ones. Often, simple hand-written grammars are sufficient for processing named entities like dates or money amount from written texts.

The situation is very different in a dialogue context. Firstly, numerical expressions are crucial as they correspond to the parameters of the queries that are going to be sent to the application database in order to fulfill a specific task. Secondly, the difficulties of retrieving such entities are increased by three different factors: recognition errors, spontaneous speech input and context-dependent named entities.

Recognition of communications over communication devices such as the telephone, videophone, interactive Internet, etc., especially with a large population of non-expert users, is a very difficult task. On the customer corpus, the average word error recognition is about 27%. Even if thus result still allows the natural language understanding unit 170 and the dialogue manger 180 to perform efficient task-type classification, there are too many errors for using the same named entity detection and extraction techniques on the recognizer 150 output as those applied on written text.

For example, the sentence “and my number is two oh one two six four twenty six ten” might be mis-recognized as “and my number is too oh one to set for twenty six ten” Therefore, instead of having one string of 10 digits for the phone number, there are 2 strings, one of 3 digits and one of 4 digits.

Processing spontaneous conversational communications does not affect just the recognizer 150. The variability of the language used by the callers can be much higher that is found in a written corpus. First, because of the dysfluencies occurring in spontaneous communications, like stops edits and repairs. Second, because of the application itself. In other words, most of the people communicating with a machine are not familiar with human-computer communication interaction and conducting a conversation without knowing the level of understanding of the “person” you are communicating with may be disturbing.

Here is an example of such an utterance, where standard text parsing techniques would be difficult to apply:

I didn't know if I was talking to a machine or I got the impression I was waiting for some further instructions there yes I just the the latest one that I just received here for an overseas call to U K it was for seventy minutes and the amount was X and I I've gone back my bills and the closest I can come is like in May I'd a ten minute and it was X.

As discussed above, most of the named entities used in a dialogue context are context-dependent. This means that a certain level of understanding of the whole sentence is necessary in order to classify a given string as a named entity. For example, for the named entity tag Which Bill in the customer care scenario, the first task is to recognize that the caller is talking about his bill. Then, the context which will allow identification of the bill may be detected. Consider the following examples:

the statement I received this morning=>tag=Which_bill, value=latest my October 2001 bill=>tag=Which_bill, value=2001/10/??

Such named entities can't be easily represented by regular grammars, as the context needed for detecting them can be quite large.

When dealing with text input, handwritten rule-based systems have proven to give the best performances on some named entity extraction tasks. But when the input is noisy (lack of punctuation or capitalization, for example) or when the text is generated by the recognizer 150, data-driven approaches seem to out perform rule-based methods. However, by carefully designing rules specific to the recognizer 150 transcripts, good performances can be achieved.

This is also the case when the named entities to process are numerical expressions: context-independent named entities, like dates and phone numbers, are generally expressed according to a set of fixed patterns which can be easily modeled by some hand-written rules in a Context-Free Grammar (CFG). These rules can be obtained by a study of a possibly small example corpus that may be manually transcribed. The main advantage of such grammars is their generalization power, regardless of the size of the original corpus they were induced from. For example, as long as a user expresses a date following a pattern recognized by the grammar, all the possible dates will be equally recognized. However, two issues arise when using CFG: one is the difficulty of taking into account recognition errors; the other one is the modeling of context-dependent named entities expressed in a spontaneous speech context. These two issues are discussed further below.

A simple insertion or substitution in a named entity expression will lead to a rejection of the expression by the grammar. A named entity detection system based only on CFG applied to the best string hypothesis generated by the recognizer 150 will have a very high false rejection rate because of the numerous insertions, substitutions and deletions occurring in the recognizer 150 hypothesis. Two possible ways to address this problem are as follows:

1) Replace the CFG by a stochastic model in order to estimate the probability of a given distortion of the canonical form of a named entity; or

2) Apply the CFG, not only to the best string hypothesis of the recognizer 150, but to the whole WCN as mentioned above.

The first possibility will be discussed below. For the second possibility, the CFGs are represented as Finite State Machines (FSM) where each path, from a starting state to a final state, corresponds to an expression accepted by the corresponding grammar. Because the handwritten grammars are not stochastic, the corresponding FSMs aren't weighted and all paths are considered equals. With this representation, applying a grammar to a WCN only consists in composing the two FSMs. Because an epsilon (empty transition exists between each state of the WCN, all the words surrounding a named entity expression will be replaced by the epsilon symbol and finding all the possible matches between a grammar and a WCN corresponds to enumerating all the possible paths in the composed FSM.

In practice, not all the possible paths need to be extracted, just the N-best ones. Because the WCN is weighted with the confidence score of each word, the best match between a grammar and the network is the expression that contains the words with the highest confidence score as well as the smallest number of epsilon transitions, corresponding to the best coverage on the WCN by the named entity expression. This technique, leads to a decrease in the false rejection rate of the detection process. Unfortunately, a decrease in correct detections is also noticeable as the number of false positive matches in the WCN is very difficult to control by means of only the word confidence scores.

Integrating spontaneous speech dysfluencies in regular grammars in order to represent named entities expressed in a user-initiative dialogue context is not an easy task. Moreover, most of the named entities relevant to the dialogue manager 180 are context-dependent in that a certain portion of the context of occurrence has to be modeled with the entity itself by the grammar. With regard to these difficulties, and thanks to the amount of transcribed data contained in the customer care corpus, it seems natural to try to induce grammars directly from the labeled data.

Each dialogue of the labeled corpus is split into turns and to each turn is attached a set of fields containing various information like the prompt name, the dialogue context, the exact transcription, the recognizer output, the NLU tags, etc. One of these fields is made of a list of triplets, one for each named entity contained in the sentence, as presented above. The field corresponding to the named entity context is supposed to contain the smallest portion of the sentence, containing the named entity, which characterizes this portion as a named entity. For example, in the sentence: I don't recognize this 22 dollar phone call on my December bill the context attached to the named entity Item_Amount is “this 22 dollar phone call” and the one attached to the named entity Which_Bill is “December bill.”

Of course such a definition relies heavily on the knowledge the labeler has of the task, and some lack of consistency can be observed between labelers. However, this corpus constitutes a precious database containing “real” spontaneous speech data with semantic information. Adding a new sample string to a CFG with a start non-terminal S consists in simply adding a new top-level production rule (for S) that covers the sample precisely. Then, a non-terminal is added for each new terminal of the right-hand side of the new rule in order to facilitate the merging process.

The key point of all the grammar induction methods is the strategy chosen for merging the different non-terminal: if no merging is performed, the grammar will only model the training examples, if too many non-terminals are merged, the grammar will accept incoherent strings. In the present case, because the word strings representing the named entity contexts are already quite small, and because the induction of a wrong pattern can heavily affect the performance of the system by generating a lot of false positive matches, the merging strategy may be limited to a set of standard non-terminals: digit, natural numbers, and day and month names. The following substitutions are considered:

each digit (0 to 9) is replaced by the token $digitA;

each natural number (from 10 to 19) is replaced by the token $digitB;

each ten number (20, 30, 40, . . . 90) is replaced by the token $digitC;

each ordinal number is replaced by the token $ord;

each name representing a day is replaced by the token $day;

each name representing a month is replaced by the token $month;

For example, the following named entity contexts, corresponding to the named entity tag item_Amount: charged for two ninety five charging me a dollar sixty five become: charged for $digitA $digitc $digita charging me a dollar $digitc $digitA.

Let's point out here that the symbols $digitA,B,C, $ord, $month and $day are considered as terminal symbols. The same kind of preprocessing operation will be performed on the text-strings that are going to be parsed by the grammars. Despite the size of the corpus available, there is not enough data for learning a reliable probability for a given named entity to be expressed in a given way. Therefore, all rules are considered are equal and the grammars obtained aren't stochastic. Each grammar rule obtained for a given named entity tag is then turned into a simple FSM, and the complete grammar for the tag is the union of all the different FSMs extracted from the corpus.

After the training phase, each named entity tag is associated with an induced grammar modeling its different expressions in the training corpus. It is therefore possible to enrich such grammars with handwritten ones as presented above. Because neither kind of the grammars is stochastic, their merging process is straightforward: the merged grammar is simply the union of the different FSMs corresponding to the different grammars. These handwritten grammars can be seen as a back-off strategy for detecting named entities.

For example, the named entity tag Which Bill can have either a value corresponding to a date (the bill issued date, for example) or to a relative position (current or previous). But not all dates can be a considered as a Which_Bill, like for example, a date corresponding to a given phone call. In the named entity context-training corpus, all the dates corresponding to a tag Which-Bill are embedded in a string clarifying the nature of the date, like: bill issued on Nov. 12, 2001.

Therefore all the strings matching a grammar built from this example are very likely to represent a Which_Bill tag. However, if the named entity is expressed in a different way and not represented in the training corpus, like bill dated Nov. 12, 2001, the grammar will reject the string. This data sparseness problem is inevitable whatever size is the training corpus when the application is dealing with spontaneous speech.

Adding handwritten rules is then an efficient way of increasing the recall of the named entity detection process. For example, in the previous example, if a handwritten grammar representing any kind of date is added to the data-induced grammar related to the tag Which_Bill, all the expressions identifying a bill by means of a date will be accepted. The first expression bill issued on Nov. 12, 2001 will still be identified by the pattern found in the training corpus, because it's longer than the simple date and gives a better coverage of the sentence. The second expression bill dated Nov. 12, 2001 will be reduced to the date itself and accepted by the back-off handwritten grammar representing the dates.

However, if this technique improves the recall, the precision drops because of all the false positive detections generated by the non context-dependent rules of the hand-written grammars. That's why such a technique has to be used in conjunction with another process, which can give a confidence score for a given context to contain a given tag. This method will be discussed further below.

Once a named entity context is detected by a grammar, a named entity value has to be extracted by the named entity extractor 420. As presented above, each named entity tag can be represented by one or several kind of values. The evaluation of a named entity processing method applied to dialogue systems has to be done on the values extracted and not the word-string itself. From the dialogue manager's 180 point of view, the normalized values of the named entities will be the parameters of any database dip, and not the string of words, symbols, or gestures used to express them.

For example, the value of the following named entity bill issued on Nov. 12, 2001 is “2001/11/12”. If the same value is extracted from the recognizer 150 output, this will be considered as a success, even if the named entity string estimated is bill of the Nov. 12, 2001 or issue the November 12th of 2001.

Evaluating the values instead of the strings is called the evaluation of the understanding accuracy. Extracting a value from a word-string can be straightforward for some simple numerical named entities, like Item_Amount. However, some ambiguities can exist, even for standard named entities like phone numbers. For example, the following number 220 386 1200 can be read as two twenty three eight six twelve hundred and this string can then be turned into these following digit strings: 2203861200 223861200 22038612100 2238612100.

In order to produce correct values, a transduction process is implemented that outputs values during the parsing by the parser 230 using the named entity grammars already presented. The result of this transduction on the previous phone string will be: two->2 twenty->20 three->3 eight->8 six->6 twelve->12 hundred->00.

For the handwritten grammars, this is done by simply adding to each terminal symbol the format of the output token that has to be generated. For example, the previous transduction is made by the rule:

<PHONE>->$digitA/$digit1 $digitC/$digit2 $digitA/$digit1 $digitA/$digit1 $digitA/$digit1 $digitB/$digit2 hundred/00. with $digit1 corresponding to the first digit of the input symbol, $digit2 to the first two digits of the input symbol, and 00 to the digit string 00.

The same process is used for data-induced grammars. In this case, word to word, the word context and the value of each sample of the training corpus are aligned first. The symbols that don't produce any output token are transduced into the epsilon symbol, and similarly the output tokens that are not produced by a word from the named entity context are considered emitted by the same epsilon symbol. This alignment is done by means of simple rules that make the correspondence, at the word level, between input symbols and output tokens.

Because all the grammars use are coded into FSMs, the extraction process is implemented as a transduction operation between these FSMs and the output of the recognizer 150. On the grammar side, the FSMs are simply transformed into transducers by adding the output tokens attached to each input symbol for each arc of the FSMs. On the recognizer 150 output side, the following process is performed:

(1) if the recognizer 150 output is a 1-best word string, it is turned into a sequential FSM, otherwise the word-lattice, or word confusion network, is used directly as an FSM;

(2) the FSM obtained is turned into a transducer by duplicating each word attached to each arc as an input and output symbol;

(3) each output symbol belonging to one of these non-terminal class: $digitA, $digitB, $digitc, $ord, $month and $day, is replaced by the name of its class.

The extraction process is now a byproduct of the detection phase. In this regard, once a string is accepted by a grammar by using a composition operation between their corresponding transducers, at the same time, the matching of the input and output symbols of both transducers will remove any ambiguities for the translation of a word string into a value. To obtain a value, one path is chosen in the composed FSM, all the epsilon output symbols are filtered, and then the other input-output symbols are matched.

Assume for example, that FSM1 is the transducer corresponding to the recognizer output and FSM2 is one of the grammars automatically induced from the training data, which represents the transduction between a named entity context like twenty two sixteen charge and the value 22.16. From FSM1, the following values can be extracted: 64.10 64.00 60.10 60.00 60.04 4.10 4.00 10.00 0.64 0.60 0.04 0.10 But after the composition between the two FSMs, the following transduction occurs:

sixty->$digit1 four->$digit1 eps->. ten->$digit10 charge->eps

Thus, in order to produce a value, the first digit of sixty and the first digit of four are taken, the token is added, the first two digits of ten are taken and the word charge is finally erase. From the twelve possible values previously enumerated, only one match is obtained, which is 64.10.

One of the main advantages of this approach is the possibility of generating an n-best solution on the named entity values instead of the named entity strings. Indeed, each path in the composed FSM between the recognizer 150 output transducer and the grammar transducer, once all the epsilon transitions have been removed, corresponds to a different named entity value. By extracting the n-best paths (according to the confidence score attached to each word in the recognizer 150 output the n-best values are automatically obtained according to the different paths, in the grammars and in the FSM produced by the recognizer 150.

In contrast, if the n-best generation is done on the word lattice alone, one has to generate a much bigger set of paths in order to obtain different values, as most of the n-best paths will differ only by words that are not used in the named entity value generation process.

Even with grammars induced from data, CFGs still remain too strict for dealing efficiently with recognizer errors and spontaneous speech effects. As discussed above, one possibility is to add non-determinism and probabilities to the grammars in order to model and estimate the likelihood of the various distortions that might occur. This approach relies heavily on the amount of data available as stochastic grammars need a lot of examples in order to estimate reliable transition probabilities. Considering that not enough data existed for estimating such grammars, and with regards to the poorer results obtained with this method compared to those obtained with a rule-based system and a Maximum-Entropy tagger, a simpler model based on a tagging approach was implemented.

Tagging methods have been widely used in order to associate to each word of a text a morphological tag called Part-Of-Speech (POS). In the framework of named entity detection, there may be one tag for each kind of named entity and a default tag corresponding to the background text, between each named entity expression.

Two kinds of models have been proposed. One is based on a state-dependent Language Model approach considering tile transition probabilities between words and tags within a sentence. The other one is based on a Maximum Entropy (ME) model. Both approaches heavily rely on the features selected for estimating the probabilities of the different models.

For example, a tagging approach based on a Language Model (LM) very close to the standard language models used during the speech recognition process is chosen. This choice has been made according to two considerations. First, having recognizer 150 transcripts instead of written text automatically limits the number of features that can be used in order to train the models. No capitalization, punctuation or format information is available, and the only parameters that can be chosen are the words from the text stream produced by the recognizer 150. The advantage of having the possibility of mixing a large scale of features as in the maximum entropy approach, this will not apply in this scenario.

Second, because of the recognizer errors (between 25% and 30% word error rate), trigger words or fixed patterns of words and/or part-of-speech cannot be implemented. Indeed, even if a word or a short phrase is very relevant for identifying a given named entity on written text input, this word or this phrase can be, for any reason, very often mis-recognized by the recognizer 150 and all the probabilities associated to them are then lost. That is why the only robust information available for tagging a word with a specific tag is simply its surrounding words within the sentence, and in this case, the language model approaches are very efficient and easy to implement.

Following the formal presentation of tagging models, named entity detection process can be further described. It is assumed that the language contains a fixed vocabulary w¹, w² . . . , w^{v}, which is the lexicon used by the recognizer 150. It is also assumed that a fixed set of named entity tags t¹ t², . . . , t^{T} and a tag t⁰ represents the background text. A particular sequence of n words is represented by the symbol w_{1,n} and for each i≧n, wᵢεw¹, w², . . . ,w^{V}.

In a similar way, a sequence of n tags is represented by t_{1,n} and for each i≧n, tᵢεt⁰,t², . . . , t^{T}. The tagging problem can then be formally defined as finding the sequence of tags t_{1,n}, in the following way:

$$τ ( {w}_{1 , n} ) = arg {max}_{{t}_{1 , n}} P ( {t}_{1 , n} \vert {w}_{1 , n} ) \qquad ( 1 )$$

Equation 1 can be turned as:

$$τ ( {w}_{1 , n} ) = arg {max}_{{t}_{1 , n}} \frac{P ( {t}_{1 , n} , {w}_{1 , n} )}{P ( {w}_{1 , n} )} \qquad ( 2 )$$

Because P(w_{1,n}) is constant for all t_{i,n},w_{1,n}), the final equation is:

$$τ ( {w}_{1 , n} ) = arg {max}_{{t}_{1 , n}} P ( {t}_{1 , n} , {w}_{1 , n} ) \qquad ( 3 )$$

For calculating P(t_{1,n},w_{1,n}), P(t₁) in equation 3 can be broken out:

$$P ( {t}_{1 , n} , {w}_{1 , n} ) = {\prod }_{i = 1}^{n} P ( {t}_{1 , i - 1} , {w}_{1 , i - 1} ) P ( {w}_{i} \vert {t}_{1 , i} , {w}_{1 , i - 1} ) \qquad ( 4 )$$

In order to collect these probabilities, the following Markov assumptions are made:

P(tᵢ|t_{1,i-1},w_{1,i-1})=P(tᵢ|t_{1-2,i-1},w_{i-2,i-1}) (5)

P(wᵢ|t_{1,i},w_{1,i-1})=P(wᵢ|t_{i-2,i},w_{i-2,i-1}) (6)

It is assumed that the tᵢ tag is only dependent of the two previous words and tags. Similarly, the word wᵢ is dependent on the two previous words and tags as well as the knowledge of its tag. Unlike the part-of-speech tagging method, it is not assumed that the current tag is independent of the previous words. This assumption is usually made because of the data sparseness problem, but in this case, the words to the history can be integrated because the number of tags are limited, and the number of different words that can be part of a named entity expression is also very limited (usually digits, natural numbers, ordinal number, and a few key words like: dollars, cents, month name, . . . ). With these assumptions, the following equation is obtained:

$$τ ( {w}_{1 , n} ) = arg {max}_{{t}_{1 , n}} P ( {t}_{i} \vert {t}_{i - 2 , i - 1} , {w}_{i - 2 , i - 1} , ) P ( {w}_{i} \vert {t}_{i - 2 , i} , {w}_{i - 2 , i - 1} ) \qquad ( 7 )$$

In order to estimate the parameters of this model, the training corpus is defined, as presented further below.

The probabilities of this tagging model are estimated on a training corpus, which contains human-computer dialogues transcribed by the transcriber 210 (or alternatively, manually transcribed). To each word wᵢ of this corpus is associated a tag tᵢ where tᵢ=t⁰ if the word doesn't belong to any named entity expression, and tᵢ=tⁿ if the word is part of an expression corresponding to the named entity tag n. This training corpus is built from the HMIHY corpus in the following way. The corpus may contain about 44K dialogues (130K sentences), for example.

This corpus is divided into a training corpus containing 35K dialogues (102K sentences) and a test corpus of 9K dialogues (28K sentences). Only about 30% of the dialogues and 15% of the sentences contain named entities. This corpus represents only the top level of the whole dialogue system, corresponding to the task classification routing process. This is why the average number of turns is rather small (around 3 turns per dialogue and the percentage of sentences containing a named entity is also small (the database queries which require a lot of named entity values are made in the legs of the dialogue and not at the top level. Nevertheless, still obtain a 16K sentence training corpus, manually transcribed, where each sentence contains at least one named entity.

All these sentences are transcribed by the transcriber 210 and semantically labeled by the labeler 220. The semantic labeling by the labeler 220 consists in giving to each sentence the list of task types that can be associated to it as well as the list of named entities contained. For example, consider the sentence

“I have a question about my bill I I don't recognize this 22 dollar call to Atlanta on my July bill.”

This sentence can be associated with the two following task types: Billing-Question and Unrecognized-Number and the named entity tags: Item_Amount, Item_Place and Which_Bill.”

In addition to these labels, 35% of the sentences containing a named entity tag have also been labeled by the labeler 220 according to the format presented above where in addition to the label itself, the named entity context and value are also extracted by the named entity extractor 420. This subset of the corpus is directly used to train the named entity training tagger 240. In this regard, a tag is added to each word belonging to a named entity context representing the named entity, and similarly the tag to is added to the background text.

The last step in the training corpus process is a non-terminal substitution process applied to digit strings, ordinal numbers, and month and day names. Because the goal of the named entity training tagger 240 is not to predict a string of words but to tag an already existing string, the generalization power of the named entity training tagger 240 can be increased by replacing some words by general non-terminal symbols. This is especially important for digit strings, as the length of a string is a very strong indicator of its purpose.

For example, 10-digit strings are very likely to represent phone numbers, but if all the digits are represented as single tokens in the training corpus, the 3-gram language model used by the named entity training tagger 240 won't be able to model accurately this phenomenon as the span of such a model is only 3 words. In contrast, by replacing the 10-digit string in the corpus by the symbol $digit10, a 3-gram LM will be able to correctly model the context surrounding these phone numbers. According to that consideration, all the N-digit strings axe replaced by the symbol $digitN, the ordinal numbers are replaced by $ord, the month names by $month and the day names by $day. The parameters of the probabilistic model of the named entity training tagger 240 are then directly estimated from this corpus by means of a simple 3-gram approach with back off for unseen events.

Tagging approaches based on language models with back off can be seen as stochastic grammars with no constraints as every path can be processed and receive a score. Therefore, the handling of the possible distortions of the named entity expressions found in the training corpus is automatic and this allows modeling of longer sequences without risking rejecting correct named entities expressed or recognized in a different way.

Thus, it is interesting to expand the contexts used to represent the named entities in the training corpus. This allows taking into account more contextual information bringing which brings two main advantages. First, some relevant information for processing ambiguous context-dependent named entities can be captured. Second, by using a larger span, the process is more robust to recognizer errors. Of course, the trade-off of this technique is the risk of data-sparseness that can occur by increasing the variability inside each named entity class. A context-expansion method may be implemented based on a syntactic criterion as follows:

(1) the training corpus is first selected and labeled according to the method presented above;

(2) then, a part-of-speech-tagging followed by a syntactic bracketing process is performed on each sentence in order to insert boundaries between each noun phrase, verbal phrase, etc;

(3) finally, all the words of each phrase that contains at least one word marked with a named entity tag are marked with the same tag.

Increasing the robustness of extraction information systems to recognizer errors is one of the current big issues of automated communication processing. As discussed above, the recognizer transcript cannot be expected to be exempt of errors, as the understanding process is linked to the transcription process. Even if statistical models are much more robust to recognizer errors than rule-based systems, the models are usually trained on manually transcribed communications and the recognizer errors are not taken into account explicitly.

This strategy certainly emphasizes the precision of the detection, but a great loss in recall can occur by not modeling the recognizer behavior. For example, a word can be considered as very salient information for detecting a particular named entity tag. But if this word is, for any reason, very often badly recognized by the recognizer system, its salience won't be useful on the recognizer output.

Some methods increase the robustness of their models to recognizer errors by randomly generating errors in order to noise the training data. But because of a mismatch between the errors generated and the ones occurring in the recognizer output, no improvement was shown using this technique. In this method, the whole training corpus is processed by the recognizer system in order to learn automatically the confusions and the mistakes that are likely to occur in the deployed system. This recognizer output corpus is then aligned by the aligner 260, at the word level, with the transcription corpus. A symbol NULL is added to the recognizer transcript for every deletion and each insertion is attached to the previous word with the symbol +. By thus means, both manual transcriptions and recognizer outputs contain the same number of tokens. The last process consists simply in transferring the tags attached to each word of the manual transcription, as presented above, to the corresponding token in the recognizer output.

Such a method balances the inconvenience of learning directly a model on a very noisy channel (recognizer output) by structuring the noisy data according to constraints obtained on the clean channel (manual transcriptions).

The named entity tagging process consists in maximizing the probability expressed by equation 7 by means of a search algorithm. The input is the best-hypothesis word string output of the recognizer module, and is pre-processed in order to replace some tokens by non-terminal symbols as discussed above. Word-lattices are not processed in this step because the tagging model is not trained for finding the best sequence of words, but instead for finding the best sequence of tags for a given word string. In the tagged string, each word is associated with a tag, t⁰ if the word is not part of any named entity, and tⁿ if the word is part of the named entity n. An SGML-like tag <n> is inserted for each transition between a word tagged t⁰ and a word tagged tⁿ. Similarly, the end of a named entity context is detected by the transition between a word tagged tⁿ and a word tagged t⁰ and is represented by the tag </n>.

In order to be able to tune the precision and the recall of the model for the deployed system, a text classifier 520 scores each named entity context detected by the tagger 510. This text classifier 520 is trained as follows:

(1) the recognizer output of the training corpus is processed by the named entity tagger;

(2) on one hand, all the contexts detected and correctly tagged according to the labels are kept and marked with the corresponding named entity tag;

(3) on the other hand, all the false positive detections are labeled with the tag OTHER;

(4) finally the text classifier 520 is trained in order to separate these samples according to their named entity tags as well as the OTHER tag.

During the tagging process, the scores given by the text classifier 520 are used as confidence scores to accept or reject a named entity tag according to a given threshold.

As discussed above, the robustness issue of CFCs: on one hand CFCs are often too strict when they are applied to the 1-best string produced by the recognizer 150, and on the other hand, applying them to the entire word lattice might generate too many false detections as there is no way of modeling their surrounding contexts of occurrence within the sentence. The tagging approach presented above provides efficient answers to these problems as the whole context of occurrence of a given named entity expression is modeled with a stochastic grammar that handles distortions due to recognizer errors or spontaneous speech effects. But this latter model can be applied only to the 1-best string produced by the recognizer module, which prevents using the whole word lattice for extracting the named entity values.

With this in mind a hybrid method may be implemented based on a 2-step process, which tries to take advantage of the two methods previously presented. First, because what the user is going to say after a given prompt cannot be predicted, the named entities on the 1-best hypothesis are detected only by means of the named entity tagger. Second, once areas in the speech input have been detected which are likely to contain named entities with a high confidence score, the named entity values from the word lattice are extracted with the CFGs but only on the areas selected by the named entity tagger. When processing a sentence, the tagger is first used in order to have a general idea of its content. Then, the transcription is refined using the word-lattice with very constrained models (the CFGs) applied locally to the areas detected by the tagger. By doing so the understanding and the transcribing processes are linked and the final transcription output is a product of the natural language understanding unit 170 instead of the recognizer 150. The general architecture of the process may include the following:

a data structure using, both for the models and the input data, the FSM format;

the preprocessor as well as the CFG grammars being represented as non-weighted transducers;

the Language Model used by the tagger being coded as a stochastic FSM;

all the steps in the named entity detection and extraction process being defined as fundamental operations between the corresponding transducers, like composition, best-path estimation and sub-graph extraction;

the information which goes to the NLU unit for the task classification process is made of the named entity tags detected, with their confidence scores given by the text classifier, as well as the preprocessed recognizer FSM;

the dialogue manager receives the named entity values extracted, with two kind of confidence score: one attached to the tag itself and one given to the value (made from the confidence scores of the words composing the value).

FIG. 7 is a flowchart of a possible task classification process using name entities. In associating a task type to each sentence of the customer care corpus, any method may be used as know to those of skill in the art, including classification methods disclosed in U.S. Pat. Nos. 5,675,707, 5,860,063, 6,021,384, 6,044,337, 6,173,261, and 6,192,110. The input of the dialogue manager 180 is a list of salient phrases detected in the sentence. These phrases are automatically acquired on a training corpus.

Named entity tags can be seen as another input for the dialogue manager 180 as they are also salient for characterizing task types. This salience can be estimated by calculating the task-type distribution for a given named entity tag. For example, in the customer care corpus, if a sentence contains an Item_Amount tag, the probability for this sentence to represent a request about an explanation on a bill (Expl_Bill is P(Expl_Bill Item_Amount)=0.35. Thus probability is only 0.09 for a task-type representing a question about an unrecognized number.

An important task of the dialogue manager 180 is to generate prompts according to the dialogue history in order to clarify the user's request and complete the task. These prompts must reflect the understanding the system has of the ongoing dialogue. Even if this understanding is correct, asking direct questions without putting them in the dialogue context may confuse the user and lead him to reformulate his query. For example, if a user mentions a phone number in a question about an unrecognized call on his bill, even if the value cannot be extracted because of a lack of confidence, acknowledging the fact that the user has already said the number (with a prompt such as “What was that number again?”) will help the user feel that he or she is being understood.

In this regard, the process in FIG. 7 begins from step 6900 in FIG. 6 and continues to step 7100. In step 7100, the dialogue manager 180 may perform task classifications based on the detected named entities and/or background text. The dialogue manager 180 may apply a confidence function based on the probabilistic relation between the recognized named entities and selected task objectives, for example. In step 7200, the dialogue manager 180 determines whether a task can be classified based on the extracted named entities.

If the task can be classified, in step 7300, the dialogue manager 180 routes the user/customer according to the classified task objective. In step 7700, the task objective is completed by the communication recognition and understanding system 100 or by another system connected directly or indirectly to the communication recognition and understanding system 100. The process then goes to step 7800 and ends.

If the task cannot be classified in step 7200 (e.g., a low confidence level has been generated), in step 7400, the dialogue manager 180 conducts dialogue with the user/customer to obtain clarification of the task objective. After dialogue has been conducted with the user/customer, in step 7500, the dialogue manager unit 180 determines whether the task can now be classified based on the additional dialog. If the task can be classified, the process proceeds to step 7300 and the user/customer is routed in accordance with the classified task objective and the process ends at step 7800. However, if task still cannot be classified, in step 7600, the user/customer is routed to a human for assistance and then the process goes to step 7800 and ends.

Although the flowchart in FIG. 7 only shows two iterations, multiple attempts to conduct dialogue with the user may be conducted in order to clarify one or more of the task objectives within the spirit and scope of the invention.

While the system and method of the invention is sometime illustrated above using words, numbers or phrases, the invention may also symbols, portions of words or sounds called morphemes (or sub-morphemes known as phone-phrases). In particular, morphemes are essentially a cluster of semantically meaningful phone sequences for classifying of utterances. The representations of the utterances at the phone level are obtained as an output of a task-independent phone recognizer. Morphemes may also be formed by the input communication recognizer 150 into a lattice structure to increase coverage, as discussed in further detail above.

It is also important to note that the morphemes may be non-acoustic (i.e., made up of non-verbal sub-morphemes such as tablet strokes, gestures, body movements, etc.). Accordingly, the invention should not be limited to just acoustic morphemes and should encompass the utilization of any sub-units of any known or future method of communication for the purposes of recognition and understanding.

Furthermore, while the terms “speech”, “phrase” and “utterance”, used throughout the description below, may connote only spoken language, it is important to note in the context of this invention, “speech”, “phrase” and “utterance” may include verbal and/or non-verbal sub-units (or sub-morphemes). Therefore, “speech”, “phrase” and “utterance” may comprise non-verbal sub-units, verbal sub-units or a combination of verbal and non-verbal sub-units within the sprit and scope of this invention.

In addition, the nature of the invention described herein is such that the method and system may be used with a variety of languages and dialects. In particular, the method and system may operate on well-known, standard languages, such as English, Spanish or French, but may operate on rare, new and unknown languages and symbols in building the database. Moreover, the invention may operate on a mix of languages, such as communications partly in one language and partly in another (e.g., several English words along with or intermixed with several Spanish words).

Note that while the above-described methods of training for and detecting and extracting named entities are shown in the figures as being associated with an input communication processing system or a task classification system, these methods may have numerous other applications. In this regard, the method of training for and detecting and extracting named entities may be applied to a wide variety of automated communication systems, including customer care systems, and should not be limited to such an input communication processing system or task classification system.

As shown in FIGS. 1, 2, 4 and 5, the method of this invention may be implemented using a programmed processor. However, method can also be implemented on a general-purpose or a special purpose computer, a programmed microprocessor or microcontroller, peripheral integrated circuit elements, an application-specific integrated circuit (ASIC) or other integrated circuits, hardware/electronic logic circuits, such as a discrete element circuit, a programmable logic device, such as a PLD, PLA, FPGA, or PAL, or the like. In general, any device on which the finite state machine capable of implementing the flowcharts shown in FIGS. 3, 6 and 7 can be used to implement the recognition and understanding system functions of this invention.

While the invention has been described with reference to the above embodiments, it is to be understood that these embodiments are purely exemplary in nature. Thus, the invention is not restricted to the particular forms shown in the foregoing embodiments. Various modifications and alterations can be made thereto without departing from the spirit and scope of the invention.

What is claimed is:

1. A method of creating a named entity language model, comprising:
recognizing input communications from a training corpus;
parsing the training corpus;
tagging the parsed training corpus;
aligning the recognized training corpus with the tagged training corpus; and
creating a named entity language model from the aligned corpus.

2. The method of claim 1, further comprising:
transcribing the training corpus.

3. The method of claim 2, wherein the transcribing step is performed automatically.

4. The method of claim 1, wherein the training corpus includes at least one of untranscribed and transcribed speech.

5. The method of claim 1, wherein the training corpus includes communications from one or more languages.

6. The method of claim 1, further comprising:
labeling the training corpus.

7. The method of claim 1, further comprising:
storing the named entity language model in a database.

8. The method of claim 1, wherein the training corpus includes at least one of verbal and non-verbal speech.

9. The method of claim 8, wherein the non-verbal speech includes the use of at least one of gestures, body movements, head movements, non-responses, text, keyboard entries, keypad entries, mouse clicks, DTMF codes, pointers, stylus, cable set-top box entries, graphical user interface entries and touchscreen entries.

10. The method of claim 1, wherein the training corpus includes multimodal speech.

11. The method of claim 1, wherein the tagging step tags the training corpus with named entity tags.

12. The method of claim 1, wherein the named entity tags are at least one of context-dependent named entity tags and context-independent named entity tags.

13. The method of claim 1, wherein named entities are represented by at least one of a tag, a context and a value.

14. The method of claim 1, wherein recognizing step recognizes a lattice from the training corpus.

15. A system that creates a named entity language model, comprising:
a recognizer that recognizes input communications from a training corpus;
a parser that parses the training corpus;
a tagger that tags the parsed training corpus;
an aligner that aligns the recognized training corpus with the tagged training corpus, and creates a named entity language model from the aligned corpus.

16. The system of claim 15, further comprising:
a transcriber that transcribes the training corpus.

17. The system of claim 16, wherein the transcriber transcribes automatically.

18. The system of claim 15, wherein the training corpus includes at least one of untranscribed and transcribed speech.

19. The system of claim 15, wherein the training corpus includes communications from one or more languages.

20. The system of claim 15, further comprising:
a labeler that labels the training corpus.

21. The system of claim 15, further comprising:
storing the named entity language model in a database.

22. The system of claim 15, wherein the training corpus includes at least one of verbal and non-verbal speech.

23. The system of claim 22, wherein the non-verbal speech includes the use of at least one of gestures, body movements, head movements, non-responses, text, keyboard entries, keypad entries, mouse clicks, DTMF codes, pointers, stylus, cable set-top box entries, graphical user interface entries and touchscreen entries.

24. The system of claim 15, wherein the training corpus includes multimodal speech.

25. The system of claim 15, wherein the tagging step tags the training corpus with named entity tags.

26. The system of claim 15, wherein the named entity tags are at least one of context-dependent named entity tags and context-independent named entity tags.

27. The system of claim 15, wherein named entities are represented by at least one of a tag, a context and a value.

28. The system of claim 15, wherein the recognizer recognizes a lattice.

29. A method of creating a named entity language model, comprising:
recognizing input communications from a training corpus;
parsing the training corpus;
tagging the parsed training corpus;
aligning the recognized training corpus with the tagged training corpus;
creating a named entity language model from the aligned corpus; and
detecting named entities in input communications using the named entity language model.
